(19) United States
(12) Patent Application Publication
(10) Pub. No.: US 2025/0383511 A1
(43) Pub. Date: Dec. 18, 2025

(54) OPTICAL FIBER CONNECTOR

(71) Applicant: Lumentum Technology UK Limited, NORTHAMPTONSHIRE (GB)

(72) Inventors: Carl YANG, Shenzhen (CN); Yunhua XU, Shenzhen (CN); Jiang DONG, Shenzhen (CN)

(21) Appl. No.: 19/130,431

(22) PCT Filed: Nov. 17, 2023
(86) PCT No.: PCT/CN2023/132318

§ 371 Date: May 15, 2025

(30) Foreign Application Priority Data
Sep. 11, 2023 (WO) PCT/CN2023/118111

(51) Int. Cl. G02B 6/38

(52) U.S. Cl. CPC G02B 6/3887

(57) ABSTRACT

An optical fiber connector includes a housing part having a first end, a second end, and an outer surface and an inner surface that laterally extend between the first and second ends, with the inner surface defining an interior volume; a fiber optic ferrule arranged in the interior volume and containing an optical fiber; a support structure arranged in the interior volume and configured to hold the fiber optic ferrule; and a spring arranged in the interior volume laterally between a support shoulder of the support structure and the second end of the housing part. The spring is configured to apply a stable pressure force to the support shoulder. Additionally, the support structure is configured to impart at least a portion of the stable pressure force to the fiber optic ferrule such that the fiber optic ferrule is pushed toward the first end with a constant pressure.

### CROSS-REFERENCE TO RELATED APPLICATION

This Patent Application claims priority to Patent Cooperation Treaty (PCT) Patent Application No. PCT/CN2023/118111, filed on Sep. 11, 2023, and entitled “OPTICAL FIBER CONNECTOR.” The disclosure of the prior Application is considered part of and is incorporated by reference into this Patent Application.

### TECHNICAL FIELD

The present disclosure relates generally to optical fiber connectors.

### BACKGROUND

An optical module may have at least one of an optical transmission function or an optical receive function. In general, in order to implement the optical transmission function and/or the optical receive function, the optical module includes one or a plurality of optical sub-assemblies (OSAs).

An OSA may be configured to convert an electrical signal into an optical signal, or vice versa. For example, an OSA may be used for optical communications in which electrical signals are used to transmit or receive information in a digital format or an analog format. An OSA configured as a transmitter may be configured to convert an electrical signal into an optical signal and transmit the optical signal over an optical fiber connected to the OSA. An OSA configured as a receiver may be configured to receive an optical signal (e.g., the optical signal transmitted by the transmitter OSA) and convert the optical signal back into an electrical signal for signal processing (e.g., demodulation or decoding). An OSA configured as a transceiver that includes both a transmitter and a receiver may be configured to transmit and receive optical signals. An optical fiber may be connected to an OSA by a fiber optic connector.

### SUMMARY

In some implementations, an optical fiber connector includes a first housing part having a first end portion, a second end portion arranged opposite to the first end portion, and a first outer surface and a first inner surface that laterally extend between the first end portion and the second end portion, wherein the first inner surface defines a first interior volume, and wherein a portion of the first inner surface, arranged at the first end portion, includes a first screw thread; a second housing part having has a third end portion, a fourth end portion arranged opposite to the third end portion, and a second outer surface and a second inner surface that laterally extend between the third end portion and the fourth end portion, wherein the second inner surface defines a second interior volume, wherein a portion of the second outer surface, arranged at the third end portion, includes a second screw thread configured to mechanically engage with the first screw thread, and wherein the third end portion includes a slot that laterally extends partially toward the fourth end portion; a first fiber optic ferrule arranged in the first interior volume, wherein the first fiber optic ferrule contains a first optical fiber; a second fiber optic ferrule arranged in the second interior volume, wherein the second fiber optic ferrule laterally extends from the fourth end portion toward the third end portion, and wherein the second fiber optic ferrule contains a second optical fiber; a C-sleeve arranged in the second interior volume and mechanically coupled to the second inner surface, wherein the C-sleeve is configured to hold the first fiber optic ferrule and the second fiber optic ferrule such that the first optical fiber is aligned with the second optical fiber; a support structure arranged in the first interior volume and configured to hold the first fiber optic ferrule, wherein the support structure includes a support shoulder and an anti-rotation protrusion that laterally extends from the support shoulder toward the first end portion of the first housing part, and wherein the anti-rotation protrusion is configured to be received in the slot to maintain the support structure and the first fiber optic ferrule at a rotationally-fixed orientation; a spring arranged in the first interior volume laterally between the support shoulder of the support structure and the second end portion of the first housing part, wherein the spring is configured to apply a stable pressure force to the support shoulder, and wherein the support structure is configured to impart at least a portion of the stable pressure force to the first fiber optic ferrule such that the first fiber optic ferrule is maintained in contact with the second fiber optic ferrule to provide a secure optical fiber connection; and a connector boot, mechanically coupled to the second end portion of the first housing part, comprising a first boot portion and a second boot portion, wherein the first boot portion is arranged in the first interior volume and is mechanically coupled to the support structure, and wherein the first fiber optic ferrule is arranged inside the first boot portion, and wherein the second boot portion is arranged outside of the first housing part, wherein the second boot portion laterally extends from the second end portion to outside of the first housing part, and wherein the second boot portion holds the first optical fiber.

In some implementations, an optical fiber connector includes a housing part having a first end, a second end arranged opposite to the first end, and an outer surface and an inner surface that laterally extend between the first end and the second end, wherein the inner surface defines an interior volume; a fiber optic ferrule arranged in the interior volume, wherein the fiber optic ferrule contains an optical fiber; a support structure arranged in the interior volume and configured to hold the fiber optic ferrule, wherein the support structure includes a support shoulder; and a spring arranged in the interior volume laterally between the support shoulder of the support structure and the second end of the housing part, wherein the spring is configured to apply a stable pressure force to the support shoulder, and wherein the support structure is configured to impart at least a portion of the stable pressure force to the fiber optic ferrule such that the fiber optic ferrule is pushed toward the first end with a constant pressure.

### BRIEF DESCRIPTION OF THE DRAWINGS

FIG. 1 shows an optical system according to one or more implementations.

FIG. 2 shows a cross-section of an optical fiber connector according to one or more

implementations.

FIG. 3 shows a diagram of the optical system.

FIG. 4 shows an internal view of an optical fiber connector.

### DETAILED DESCRIPTION

The following detailed description of example implementations refers to the accompanying drawings. The same reference numbers in different drawings may identify the same or similar elements.

At present, single-mode fiber optic connector types include FC/PC, FC/APC, ST/PC, LC/PC, SC/SC, and micro-LC, where LC denotes Lucent connector, SC denotes square connector, ST denotes straight tip, FC denotes ferrule connector, PC denotes physical contact, and APC denotes angled physical connect. PC and APC refer to polish styles of a ferrule inside the single-mode fiber optic connectors.

For a new generation of coherent devices and modules, such as a 32 G smart transmitter receiver optical sub-assembly (TROSA), optical module interface densities are increasing, while sizes of the coherent devices and modules are becoming smaller as a result of miniaturization. Thus, standard fiber optic connectors are too large for applications that include the new generation of coherent devices and modules. Therefore, it is necessary to develop a compact and reliable optical fiber connector that can be used for the new generation of coherent devices and modules.

Some implementations are directed to a single-mode optical fiber connector that has a smaller size and is adaptable to miniaturized optical modules, including 32 G smart TROSAs. For example, an overall size of the single-mode optical fiber connector may be 5 millimeters (mm)×13 mm long, which is about 50% of a standard FC connector size (e.g., ˜9.8 mm×20 mm long). A length of an LC may be up to 30 mm long. In addition, the single-mode optical fiber connector provides a stable connection between two optical fibers. For example, the single-mode optical fiber connector has an internal spring that provides a stable connection between the two optical fibers, allowing repeated fiber connections. A structure of the single-mode optical fiber connector uses screw threads to lock an optical clamp. Thus, the single-mode optical fiber connector may provide a good optical connection with low optical insertion loss, and may meet generic requirement 326 (GR-326) standard test conditions, such as a GR-326 standard straight and side pull test.

In some implementations, the single-mode optical fiber connector includes fine-threaded screws to secure two independent optical fiber inserts together. Thus, the single-mode optical fiber connector uses a different connection mechanism and is smaller than a standard single-mode fiber optic connector, making the single-mode optical fiber connector suitable for miniaturized optical module applications that are applicable to the new generation of coherent devices and modules.

The single-mode optical fiber connector may include a first ceramic ferrule that holds a first fiber core (e.g., a first optical fiber having the first fiber core), and a second ceramic ferrule that holds a second fiber core (e.g., a second optical fiber having the second fiber core). The single-mode optical fiber connector may be configured to align the first fiber core with the second fiber core and maintain the first fiber core with the second fiber core in alignment such that signal light is guided from one fiber core to the other fiber core. Thus, the single-mode optical fiber connector may be configured to align the first optical fiber and the second optical fiber such that the first fiber core is aligned with the second fiber core. The single-mode optical fiber connector may also align a first cladding of the first optical fiber with a second cladding of the second optical fiber.

The single-mode optical fiber connector may further include a stainless-steel part with a fine-threaded screw thread, a stainless-steel housing with a fine-threaded screw thread (e.g., the stainless-steel housing has a 5 mm outer diameter), an internal C-sleeve configured to hold the first ceramic ferrule and the second ceramic ferrule in alignment, an internal mechanism to prevent rotation (e.g., so that a polarized optical fiber can also be used), an internal stainless-steel part to hold the second ceramic ferrule, an internal spring to provide a stable pressure force, and a customized connector boot configured to protect the second optical fiber to meet a GR-326 straight and side pull test.

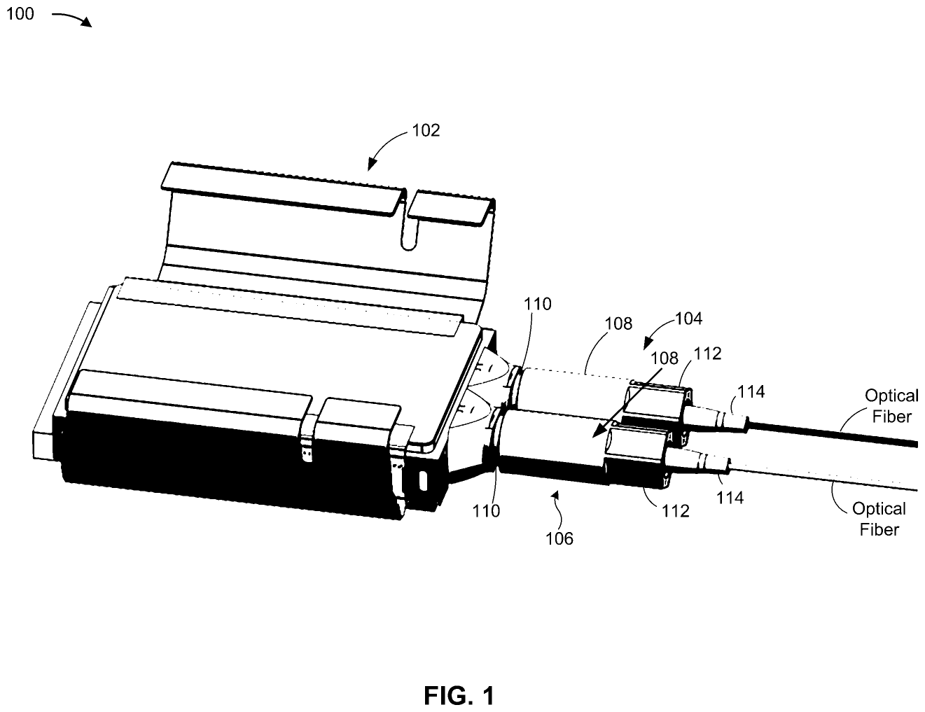

FIG. 1 shows an optical system 100 according to one or more implementations. The optical system 100 includes an optical sub-assembly 102 with two single-mode optical fiber connectors coupled to the optical sub-assembly 102. The two single-mode optical fiber connectors include a first optical fiber connector 104 and a second optical fiber connector 106. The first optical fiber connector 104 and the second optical fiber connector 106 may be identical in structure. For example, both the first optical fiber connector 104 and the second optical fiber connector 106 may have a first housing part 108 and a second housing part 110. The first housing part 108 may correspond to a first connector part of each of the two single-mode optical fiber connectors and the second housing part 110 correspond to a second connector part of each of the two single-mode optical fiber connectors. The second housing part 110 of the first optical fiber connector 104 and the second optical fiber connector 106 may be respectively coupled to or integrated with a corresponding optical port of the optical sub-assembly 102.

The second housing part 110 may be at least partially inserted into the first housing part 108. Thus, the first housing part 108 may be configured to receive the second housing part 110. In some implementations, the first housing part 108 may be threaded onto the second housing part 110 such that the first housing part 108 is mechanically coupled to the second housing part 110. For example, the first housing part 108 may have an internal screw thread (e.g., an inward facing screw thread) and the second housing part 110 may have an external screw thread (e.g., an outward facing screw thread) that corresponds to the internal screw thread. The internal screw thread of the first housing part 108 may be configured to mechanically engage with the external screw thread of the second housing part 110 to provide a mechanically coupling of the first housing part 108 and the second housing part 110. The first optical fiber connector 104 and the second optical fiber connector 106 may each have a fastener portion 112 configured to engage with a wrench or other fastening tool that is used to rotate the first optical fiber connector 104 in a clockwise direction or a counter-clockwise direction for tightening the first optical fiber connector 104 onto the second optical fiber connector 106 (e.g., for coupling the first optical fiber connector 104 to the second optical fiber connector 106) or loosening the first optical fiber connector 104 from the second optical fiber connector 106 (e.g., for decoupling the first optical fiber connector 104 from the second optical fiber connector 106).

In some implementations, the first housing part 108 may be a first cylindrical stainless-steel part, and the second housing part 110 may be a second cylindrical stainless-steel part. An inner diameter of first housing part 108 may substantially coincide with an outer diameter of the second housing part 110 such that the first housing part 108 can be fastened to the second housing part 110 using the internal screw thread and the external screw thread. Both the first housing part 108 and the second housing part 110 may have respective interior volumes that include additional components. For example, the first housing part 108 and the second housing part 110 may each include a fiber optic pigtail. A “fiber optic pigtail” is a fiber optic fiber terminated with a factory-installed connector on one end, leaving the other end exposed (e.g., without a factory-installed connector). Thus, the first housing part 108 may include a first fiber optic pigtail as a first optical fiber, and the second housing part 110 may include a second fiber optic pigtail as a second optical fiber. The second housing part 110 may be attached to an optical device, such as the optical sub-assembly 102, and a bare fiber or the fiber optic pigtail may be inserted into the optical device. The first optical fiber and the second optical fiber are brought into contact and coupled together with a constant and stable pressure when the first housing part 108 is fastened to the second housing part 110. A portion of the first optical fiber may extend into the interior volume of the second housing part 110 to make an optical connection and a physical connection with the second optical fiber.

The first optical fiber connector 104 and the second optical fiber connector 106 both include a connector boot 114 that is mechanically coupled to the first housing part 108. The connector boot 114 is configured to protect an optical fiber (e.g., the first optical fiber) that is inserted into the first housing part 108. In addition, the connector boot 114 may be configured to satisfy the GR-326 standard straight and side pull test.

As indicated above, FIG. 1 is provided as an example. Other examples may differ from what is described with regard to FIG. 1.

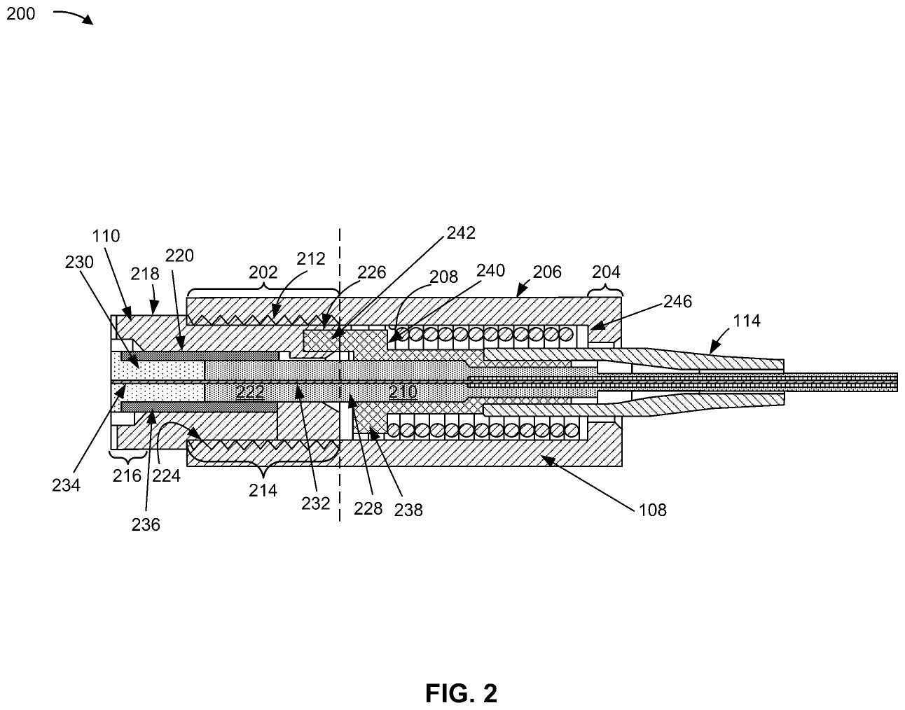

FIG. 2 shows a cross-section of an optical fiber connector 200 according to one or more implementations. The optical fiber connector 200 may correspond to the first optical fiber connector 104 or the second optical fiber connector 106 described in connection with FIG. 1. Thus, the optical fiber connector 200 includes the first housing part 108 and the second housing part 110.

The first housing part 108 has a first end portion 202 corresponding to a first end, a second end portion 204 arranged opposite to the first end portion 202 and corresponding to a second end. The first housing part 108 may further include a first outer surface 206 and a first inner surface 208 that laterally extend between the first end portion 202 and the second end portion 204. The first inner surface may define a first interior volume 210. In addition, a portion of the first inner surface 208, arranged at the first end portion 202, may include a first screw thread 212 (e.g., an internal screw thread).

The second housing part 110 has a third end portion 214 corresponding to a third end, a fourth end portion 216 arranged opposite to the third end portion 214 and corresponding to a fourth end. The second housing part 110 may further include a second outer surface 218 and a second inner surface 220 that laterally extend between the third end portion 214 and the fourth end portion 216. The second inner surface 220 may define a second interior volume 222. In addition, a portion of the second outer surface 218, arranged at the third end portion 214, may include a second screw thread 224 (e.g., an external screw thread) that is configured to mechanically engage with the first screw thread 212. In other words, the first screw thread 212 may be configured to be threaded onto the second screw thread 224 such that the first end portion 202 of the first housing part 108 is mechanically coupled to the third end portion 214 of the second housing part 110. For example, the second housing part 110 may be arranged partially inside the first interior volume 210 when the first screw thread 212 is threaded onto the second screw thread 224 for fastening the first housing part 108 to the second housing part 110. In other words, the third end portion 214 of the second housing part 110 may be inserted into the first end portion 202 of the first housing part 108 when the first housing part 108 and the second housing part 110 are coupled together. Thus, the first screw thread 212 and the second screw thread 224 may be used to secure the first housing part 108 to the second housing part 110. In addition, the third end portion 214 may include a slot 226 that laterally extends from the third end partially toward the fourth end portion 216.

The optical fiber connector 200 may further include a first fiber optic ferrule 228 and a second fiber optic ferrule 230. The first fiber optic ferrule 228 may be arranged in the first interior volume 210 and may contain a first optical fiber 232. The second fiber optic ferrule 230 may be arranged in the second interior volume 222 and may contain a second optical fiber 234. In addition, the second fiber optic ferrule 230 may laterally extend from the fourth end portion 216 toward the third end portion 214 of the second housing part 110. In some implementations, the first fiber optic ferrule 228 and the second fiber optic ferrule 230 may be made of a ceramic material.

The optical fiber connector 200 may further include a C-sleeve 236 arranged in the second interior volume 222 and mechanically coupled to the second inner surface 220. The C-sleeve 236 may be configured to hold the first fiber optic ferrule 228 and the second fiber optic ferrule 230 such that the first optical fiber 232 is aligned with the second optical fiber 234. When the first housing part 108 is coupled to the second housing part 110, the first fiber optic ferrule 228 may extend from the first interior volume 210 into the second interior volume 222 to make contact with the second fiber optic ferrule 230 inside the C-sleeve 236. Thus, during coupling of the first housing part 108 to the second housing part 110, the first fiber optic ferrule 228 may be inserted into the C-sleeve 236. The C-sleeve 236 may be configured to hold both the first fiber optic ferrule 228 and the second fiber optic ferrule 230 in alignment to ensure that the first optical fiber 232 and the second optical fiber 234 are aligned. As a result, the C-sleeve 236 may maintain a fiber core of the first optical fiber 232 and a fiber core of the second optical fiber 234 in alignment such that signal light (e.g., laser light) is guided from one fiber core to the other fiber core. The C-sleeve 236 may also align a cladding of the first optical fiber 232 with a cladding of the second optical fiber 234. Thus, the C-sleeve 236, mechanically coupled to or otherwise mechanically engaged with the first fiber optic ferrule 228 and the second fiber optic ferrule 230, may be configured to ensure good alignment between the first fiber optic ferrule 228 and the second fiber optic ferrule 230, which ensures good alignment between the two fiber cores for light propagation between the two optical fibers 232 and 234.

The optical fiber connector 200 may further include a support structure 238 arranged in the first interior volume 210 and configured to hold the first fiber optic ferrule 228. The support structure 238 may include a support shoulder 240 and an anti-rotation protrusion 242 that laterally extends from the support shoulder 240 toward the first end portion 202 (e.g., toward the first end) of the first housing part 108. Moreover, the anti-rotation protrusion 242 may be a anti-rotation locking part configured to be received in the slot 226 of the second housing part 110 to maintain the support structure 238 and the first fiber optic ferrule 228 at a rotationally-fixed orientation. The C-sleeve 236 may also hold the second fiber optic ferrule 230 in a rotationally-fixed orientation. The first optical fiber 232 and the second optical fiber 234 may be polarized optical fibers that carry polarized light with a fixed polarization. Thus, the anti-rotation protrusion 242 may be used to maintain the polarized light in a desired polarization.

The optical fiber connector 200 may further include a spring 244 arranged in the first interior volume 210 laterally between the support shoulder 240 of the support structure 238 and the second end portion 204 of the first housing part 108. For example, the second end portion 204 may include a housing shoulder 246, and the spring may laterally extend between the support shoulder 240 and the housing shoulder 246. Part of the support structure 238 may be arranged within an interior area of the spring 244. The spring 244 may be configured to apply a stable pressure force to the support shoulder 240. The support structure 238 is configured to impart at least a portion of the stable pressure force to the first fiber optic ferrule 228 such that the first fiber optic ferrule 228 is maintained in contact with the second fiber optic ferrule 230 to provide a secure optical fiber connection.

For example, the spring 244 may be configured to, based on the first screw thread 212 being threaded onto the second screw thread 224, compress between the support shoulder 240 and the housing shoulder 246, resulting in the spring 244 applying the stable pressure force to the support shoulder 240. Since the support structure 238 is mechanically fixed to the first fiber optic ferrule 228, the support structure 238 may be configured to push the first fiber optic ferrule 228 into the second fiber optic ferrule 230 based on the stable pressure force produced by the spring 244 to maintain constant contact pressure between the first fiber optic ferrule 228 and the second fiber optic ferrule 230. The stable pressure force may be an outward lateral force configured to push the first fiber optic ferrule 228 toward the second fiber optic ferrule 230 such that the first fiber optic ferrule 228 is maintained in contact with the second fiber optic ferrule 230 with a constant pressure.

The stable pressure force may be produced by fastening the first housing part 108 to the second housing part 110 to lock an optical clamp. For example, the support structure 238 may be configured to, during coupling of the first housing part 108 to the second housing part 110, make contact with the third end portion 214 (e.g., to the third end), resulting in a compression of the spring 244 and resulting in the stable pressure force being applied by the spring 244 to the support shoulder 240 based on the compression of the spring 244. The support structure 238, being mechanically fixed to the first fiber optic ferrule 228, may transfer at least a portion of the stable pressure force to the first fiber optic ferrule 228, pushing the first fiber optic ferrule 228 into the second fiber optic ferrule 230. Due to the alignment provided by the C-sleeve 236 and the constant contact pressure maintained between the first fiber optic ferrule 228 and the second fiber optic ferrule 230, the optical fiber connector 200 may provide an insertion loss with a magnitude of 0.2 dB or less. In addition, the stable pressure force may also cause the anti-rotation protrusion 242 to be pushed into the slot 226 to order to lock the support structure 238 and the first fiber optic ferrule 228 into the rotationally-fixed orientation.

The optical fiber connector 200 may further include the connector boot 114. The connector boot 114 may be mechanically coupled to the second end portion 204 of the first housing part 108. In addition, the connector boot 114 may include a first boot portion and a second boot portion. The first boot portion is arranged in the first interior volume 210 and is mechanically coupled to the support structure 238. Moreover, the first fiber optic ferrule 228 may be partially arranged inside the first boot portion. The second boot portion is arranged outside of the first housing part 108. Thus, the second boot portion laterally extends from the second end portion 204 to outside of the first housing part 108. The second boot portion holds and protects the first optical fiber 232. The connector boot 114 may be configured to protect the first optical fiber 232 according to a GR-326 standard. For example, the connector boot 114 may be configured to a GR-326 straight and side pull test. The connector boot 114 may also relieve or reduce strain on the first optical fiber 232.

As indicated above, FIG. 2 is provided as an example. Other examples may differ from what is described with regard to FIG. 2. For example, stainless-steel and/or ceramic may be replaced with other suitable materials.

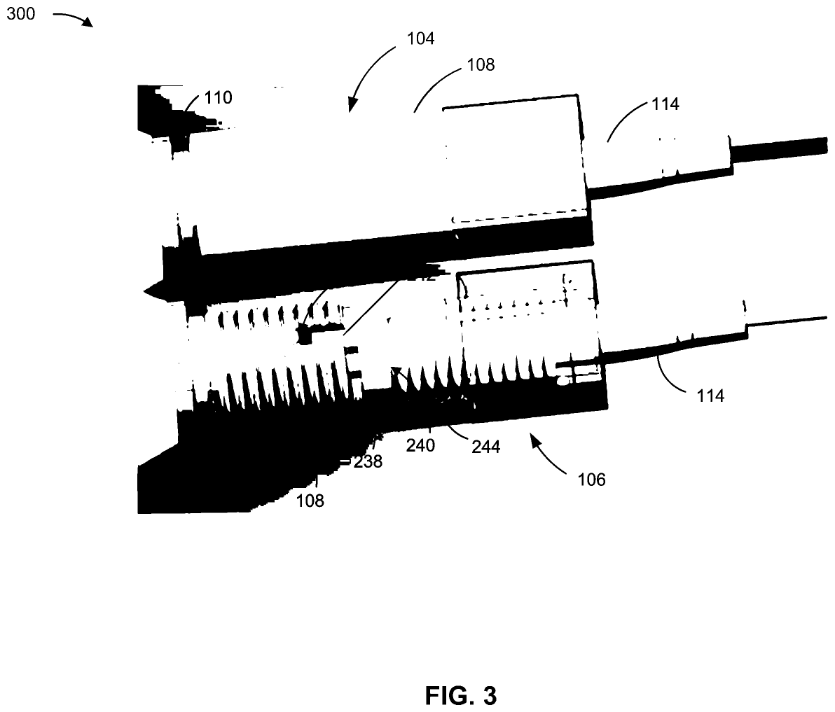

FIG. 3 shows a diagram 300 of the optical system 100. In particular, the first optical fiber connector 104 and the second optical fiber connector 106 are shown, as described in connection with FIGS. 1 and 2. The first housing part 108 of the second optical fiber connector 106 is transparent in order to show internal components of the second optical fiber connector 106, including the second screw thread 224 of the third end portion 214 of the second housing part 110, the slot 226 of the second housing part 110, the support structure 238, including the support shoulder 240 and the anti-rotation protrusion 242, and the spring 244. The anti-rotation protrusion 242 is inserted into the slot 226 to prevent rotation of the support structure 238.

As indicated above, FIG. 3 is provided as an example. Other examples may differ from what is described with regard to FIG. 3.

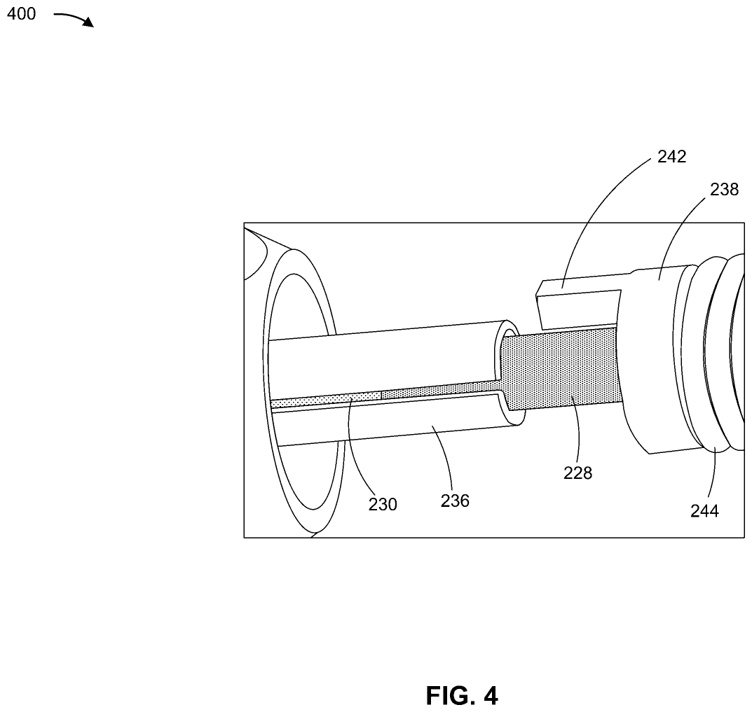

FIG. 4 shows an internal view 400 of an optical fiber connector. The optical fiber connector may correspond to the first optical fiber connector 104 or the second optical fiber connector 106, as described in connection with FIGS. 1-3. In particular, the internal view 400 shows the first fiber optic ferrule 228 and the second fiber optic ferrule 230 arranged inside the C-sleeve 236. The C-sleeve 236 may be configured to hold both the first fiber optic ferrule 228 and the second fiber optic ferrule 230 in alignment to ensure that the first optical fiber 232 and the second optical fiber 234 are aligned.

As indicated above, FIG. 4 is provided as an example. Other examples may differ from what is described with regard to FIG. 4.

The following provides an overview of some Aspects of the present disclosure:

Aspect 1: An optical fiber connector, comprising: a first housing part having a first end portion, a second end portion arranged opposite to the first end portion, and a first outer surface and a first inner surface that laterally extend between the first end portion and the second end portion, wherein the first inner surface defines a first interior volume, and wherein a portion of the first inner surface, arranged at the first end portion, includes a first screw thread; a second housing part having has a third end portion, a fourth end portion arranged opposite to the third end portion, and a second outer surface and a second inner surface that laterally extend between the third end portion and the fourth end portion, wherein the second inner surface defines a second interior volume, wherein a portion of the second outer surface, arranged at the third end portion, includes a second screw thread configured to mechanically engage with the first screw thread, and wherein the third end portion includes a slot that laterally extends partially toward the fourth end portion; a first fiber optic ferrule arranged in the first interior volume, wherein the first fiber optic ferrule contains a first optical fiber; a second fiber optic ferrule arranged in the second interior volume, wherein the second fiber optic ferrule laterally extends from the fourth end portion toward the third end portion, and wherein the second fiber optic ferrule contains a second optical fiber; a C-sleeve arranged in the second interior volume and mechanically coupled to the second inner surface, wherein the C-sleeve is configured to hold the first fiber optic ferrule and the second fiber optic ferrule such that the first optical fiber is aligned with the second optical fiber; a support structure arranged in the first interior volume and configured to hold the first fiber optic ferrule, wherein the support structure includes a support shoulder and an anti-rotation protrusion that laterally extends from the support shoulder toward the first end portion of the first housing part, and wherein the anti-rotation protrusion is configured to be received in the slot to maintain the support structure and the first fiber optic ferrule at a rotationally-fixed orientation; a spring arranged in the first interior volume laterally between the support shoulder of the support structure and the second end portion of the first housing part, wherein the spring is configured to apply a stable pressure force to the support shoulder, and wherein the support structure is configured to impart at least a portion of the stable pressure force to the first fiber optic ferrule such that the first fiber optic ferrule is maintained in contact with the second fiber optic ferrule to provide a secure optical fiber connection; and a connector boot, mechanically coupled to the second end portion of the first housing part, comprising a first boot portion and a second boot portion, wherein the first boot portion is arranged in the first interior volume and is mechanically coupled to the support structure, and wherein the first fiber optic ferrule is arranged inside the first boot portion, and wherein the second boot portion is arranged outside of the first housing part, wherein the second boot portion laterally extends from the second end portion to outside of the first housing part, and wherein the second boot portion holds the first optical fiber.

Aspect 2: The optical fiber connector of Aspect 1, wherein the second boot portion protects the first optical fiber.

Aspect 3: The optical fiber connector of any of Aspects 1-2, wherein the connector boot is configured to satisfy a GR-326 standard straight and side pull test.

Aspect 4: The optical fiber connector of any of Aspects 1-3, wherein the second end portion includes a housing shoulder, and the spring laterally extends between the support shoulder and the housing shoulder.

Aspect 5: The optical fiber connector of any of Aspects 1-4, wherein the spring is configured to, based on the first screw thread being threaded onto the second screw thread, compress, resulting in the spring applying the stable pressure force to the support shoulder.

Aspect 6: The optical fiber connector of any of Aspects 1-5, wherein the first fiber optic ferrule extends from the first interior volume into the second interior volume to make contact with the second fiber optic ferrule inside the C-sleeve.

Aspect 7: The optical fiber connector of any of Aspects 1-6, wherein the first fiber optic ferrule is configured to, during coupling of the first housing part to the second housing part, extend from the first interior volume into the second interior volume to make contact with the second fiber optic ferrule inside the C-sleeve.

Aspect 8: The optical fiber connector of any of Aspects 1-7, wherein the support structure is configured to, during coupling of the first housing part to the second housing part, make contact with the third end portion, resulting in a compression of the spring and resulting in the stable pressure force being applied by the spring to the support shoulder based on the compression of the spring.

Aspect 9: The optical fiber connector of any of Aspects 1-8, wherein the second housing part is arranged partially inside the first interior volume.

Aspect 10: The optical fiber connector of any of Aspects 1-9, wherein the support structure is arranged within an interior area of the spring.

Aspect 11: The optical fiber connector of any of Aspects 1-10, wherein the first boot portion is arranged within an interior area of the spring.

Aspect 12: The optical fiber connector of any of Aspects 1-11, wherein the stable pressure force is an outward lateral force configured to push the first fiber optic ferrule toward the second fiber optic ferrule such that the first fiber optic ferrule is maintained in contact with the second fiber optic ferrule with a constant pressure.

Aspect 13: The optical fiber connector of any of Aspects 1-12, wherein the second fiber optic ferrule extends from the fourth end portion toward the third end portion.

Aspect 14: The optical fiber connector of any of Aspects 1-13, wherein the support structure is mechanically fixed to the first fiber optic ferrule.

Aspect 15: The optical fiber connector of Aspect 14, wherein the support structure is configured to push the first fiber optic ferrule into the second fiber optic ferrule based on the stable pressure force to maintain constant contact pressure between the second fiber optic ferrule and the first fiber optic ferrule.

Aspect 16: The optical fiber connector of any of Aspects 1-15, wherein the first screw thread is configured to be threaded onto the second screw thread such that the first end portion of the first housing part is mechanically coupled to the third end portion of the second housing part.

Aspect 17: The optical fiber connector of any of Aspects 1-16, wherein the first housing part is a first cylindrical stainless-steel part, and wherein the second housing part is a second cylindrical stainless-steel part.

Aspect 18: The optical fiber connector of any of Aspects 1-17, wherein the support structure is made of stainless-steel.

Aspect 19: The optical fiber connector of any of Aspects 1-18, wherein the optical fiber connector is configured to provide an insertion loss with a magnitude of 0.2 dB or less.

Aspect 20: An optical fiber connector, comprising: a housing part having a first end, a second end arranged opposite to the first end, and an outer surface and an inner surface that laterally extend between the first end and the second end, wherein the inner surface defines an interior volume; a fiber optic ferrule arranged in the interior volume, wherein the fiber optic ferrule contains an optical fiber; a support structure arranged in the interior volume and configured to hold the fiber optic ferrule, wherein the support structure includes a support shoulder; and a spring arranged in the interior volume laterally between the support shoulder of the support structure and the second end of the housing part, wherein the spring is configured to apply a stable pressure force to the support shoulder, and wherein the support structure is configured to impart at least a portion of the stable pressure force to the fiber optic ferrule such that the fiber optic ferrule is pushed toward the first end with a constant pressure.

Aspect 21: The optical fiber connector of Aspect 20, further comprising: an anti-rotation locking part arranged in the interior volume, wherein the anti-rotation locking part laterally extends from the support structure toward the first end of the housing part, and wherein the anti-rotation locking part is configured to maintain the support structure and the fiber optic ferrule at a rotationally-fixed orientation.

Aspect 22: The optical fiber connector of any of Aspects 20-21, further comprising: a connector boot, mechanically coupled to the second end of the housing part, wherein the connector boot comprises a first boot portion and a second boot portion, wherein the first boot portion is arranged in the interior volume and is mechanically coupled to the support structure, and wherein the fiber optic ferrule is arranged inside the first boot portion, and wherein the second boot portion is arranged outside of the housing part, wherein the second boot portion laterally extends from the second end to outside of the housing part, and wherein the second boot portion holds the optical fiber.

Aspect 23: The optical fiber connector of any of Aspects 20-22, wherein a portion of the inner surface, arranged at the first end, includes a screw thread configured to mechanically engage with a corresponding screw thread of a connector part.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical fiber connector, comprising:
a first housing part having a first end portion, a second end portion arranged opposite to the first end portion, and a first outer surface and a first inner surface that laterally extend between the first end portion and the second end portion, wherein the first inner surface defines a first interior volume, and wherein a portion of the first inner surface, arranged at the first end portion, includes a first screw thread;
a second housing part having has a third end portion, a fourth end portion arranged opposite to the third end portion, and a second outer surface and a second inner surface that laterally extend between the third end portion and the fourth end portion, wherein the second inner surface defines a second interior volume, wherein a portion of the second outer surface, arranged at the third end portion, includes a second screw thread configured to mechanically engage with the first screw thread, and wherein the third end portion includes a slot that laterally extends partially toward the fourth end portion;
a first fiber optic ferrule arranged in the first interior volume, wherein the first fiber optic ferrule contains a first optical fiber;
a second fiber optic ferrule arranged in the second interior volume, wherein the second fiber optic ferrule laterally extends from the fourth end portion toward the third end portion, and wherein the second fiber optic ferrule contains a second optical fiber;
a C-sleeve arranged in the second interior volume and mechanically coupled to the second inner surface, wherein the C-sleeve is configured to hold the first fiber optic ferrule and the second fiber optic ferrule such that the first optical fiber is aligned with the second optical fiber;
a support structure arranged in the first interior volume and configured to hold the first fiber optic ferrule, wherein the support structure includes a support shoulder and an anti-rotation protrusion that laterally extends from the support shoulder toward the first end portion of the first housing part, and wherein the anti-rotation protrusion is configured to be received in the slot to maintain the support structure and the first fiber optic ferrule at a rotationally-fixed orientation;
a spring arranged in the first interior volume laterally between the support shoulder of the support structure and the second end portion of the first housing part, wherein the spring is configured to apply a stable pressure force to the support shoulder, and wherein the support structure is configured to impart at least a portion of the stable pressure force to the first fiber optic ferrule such that the first fiber optic ferrule is maintained in contact with the second fiber optic ferrule to provide a secure optical fiber connection; and
a connector boot, mechanically coupled to the second end portion of the first housing part, comprising a first boot portion and a second boot portion,
wherein the first boot portion is arranged in the first interior volume and is mechanically coupled to the support structure, and wherein the first fiber optic ferrule is arranged inside the first boot portion, and
wherein the second boot portion is arranged outside of the first housing part, wherein the second boot portion laterally extends from the second end portion to outside of the first housing part, and wherein the second boot portion holds the first optical fiber.

2. The optical fiber connector of claim 1, wherein the second boot portion protects the first optical fiber.

3. The optical fiber connector of claim 1, wherein the connector boot is configured to satisfy a generic requirement 326 (GR-326) standard straight and side pull test.

4. The optical fiber connector of claim 1, wherein the second end portion includes a housing shoulder, and
the spring laterally extends between the support shoulder and the housing shoulder.

5. The optical fiber connector of claim 1, wherein the spring is configured to, based on the first screw thread being threaded onto the second screw thread, compress, resulting in the spring applying the stable pressure force to the support shoulder.

6. The optical fiber connector of claim 1, wherein the first fiber optic ferrule extends from the first interior volume into the second interior volume to make contact with the second fiber optic ferrule inside the C-sleeve.

7. The optical fiber connector of claim 1, wherein the first fiber optic ferrule is configured to, during coupling of the first housing part to the second housing part, extend from the first interior volume into the second interior volume to make contact with the second fiber optic ferrule inside the C-sleeve.

8. The optical fiber connector of claim 1, wherein the support structure is configured to, during coupling of the first housing part to the second housing part, make contact with the third end portion, resulting in a compression of the spring and resulting in the stable pressure force being applied by the spring to the support shoulder based on the compression of the spring.

9. The optical fiber connector of claim 1, wherein the second housing part is arranged partially inside the first interior volume.

10. The optical fiber connector of claim 1, wherein the support structure is arranged within an interior area of the spring.

11. The optical fiber connector of claim 1, wherein the first boot portion is arranged within an interior area of the spring.

12. The optical fiber connector of claim 1, wherein the stable pressure force is an outward lateral force configured to push the first fiber optic ferrule toward the second fiber optic ferrule such that the first fiber optic ferrule is maintained in contact with the second fiber optic ferrule with a constant pressure.

13. The optical fiber connector of claim 1, wherein the second fiber optic ferrule extends from the fourth end portion toward the third end portion.

14. The optical fiber connector of claim 1, wherein the support structure is mechanically fixed to the first fiber optic ferrule.

15. The optical fiber connector of claim 14, wherein the support structure is configured to push the first fiber optic ferrule into the second fiber optic ferrule based on the stable pressure force to maintain constant contact pressure between the second fiber optic ferrule and the first fiber optic ferrule.

16. The optical fiber connector of claim 1, wherein the first screw thread is configured to be threaded onto the second screw thread such that the first end portion of the first housing part is mechanically coupled to the third end portion of the second housing part.

17. The optical fiber connector of claim 1, wherein the first housing part is a first cylindrical stainless-steel part, and
wherein the second housing part is a second cylindrical stainless-steel part.

18. The optical fiber connector of claim 1, wherein the support structure is made of stainless-steel.

19. The optical fiber connector of claim 1, wherein the optical fiber connector is configured to provide an insertion loss with a magnitude of 0.2 dB or less.

20. An optical fiber connector, comprising:
a housing part having a first end, a second end arranged opposite to the first end, and an outer surface and an inner surface that laterally extend between the first end and the second end, wherein the inner surface defines an interior volume;
a fiber optic ferrule arranged in the interior volume, wherein the fiber optic ferrule contains an optical fiber;
a support structure arranged in the interior volume and configured to hold the fiber optic ferrule, wherein the support structure includes a support shoulder; and
a spring arranged in the interior volume laterally between the support shoulder of the support structure and the second end of the housing part, wherein the spring is configured to apply a stable pressure force to the support shoulder, and wherein the support structure is configured to impart at least a portion of the stable pressure force to the fiber optic ferrule such that the fiber optic ferrule is pushed toward the first end with a constant pressure.

21. The optical fiber connector of claim 20, further comprising:
an anti-rotation locking part arranged in the interior volume, wherein the anti-rotation locking part laterally extends from the support structure toward the first end of the housing part, and wherein the anti-rotation locking part is configured to maintain the support structure and the fiber optic ferrule at a rotationally-fixed orientation.

22. The optical fiber connector of claim 20, further comprising:
a connector boot, mechanically coupled to the second end of the housing part, wherein the connector boot comprises a first boot portion and a second boot portion,
wherein the first boot portion is arranged in the interior volume and is mechanically coupled to the support structure, and wherein the fiber optic ferrule is arranged inside the first boot portion, and
wherein the second boot portion is arranged outside of the housing part, wherein the second boot portion laterally extends from the second end to outside of the housing part, and wherein the second boot portion holds the optical fiber.

23. The optical fiber connector of claim 20, wherein a portion of the inner surface, arranged at the first end, includes a screw thread configured to mechanically engage with a corresponding screw thread of a connector part.
